(19) United States
(12) Patent Application Publication
(10) Pub. No.: US 2026/0088698 A1
(43) Pub. Date: Mar. 26, 2026

(54) DYNAMIC CONTROL STRATEGY FOR TWO-LEVEL DC-DC CONVERTERS

(71) Applicant: Caterpillar Inc., Peoria, IL (US)

(72) Inventors: Zeljko R. Jankovic, Mequon, WI (US); Srevidhya Devi, Chennai (IN); Likhita Ravuri, Peoria, IL (US); Jyothiraditya Ramaswamy, Anupuram (IN); Ahmed Khalil, Dunlap, IL (US); Jackson Wai, Dunlap, IL (US); James Thorne, Peoria, IL (US)

(73) Assignee: Caterpillar Inc., Peoria, IL (US)

(21) Appl. No.: 18/891,462

(22) Filed: Sep. 20, 2024

(51) Int. Cl. H02M 1/00; H02M 3/335

(52) U.S. Cl. CPC H02M 1/0043; H02M 1/0058; H02M 3/33573; H02M 3/33576

(57) ABSTRACT

This disclosure describes techniques that address the unequal loss distribution between switches in two H bridge legs of two-level PSFB and DAB converters, where one leg reaches its temperature limit sooner than the other leg due to imbalanced losses. The techniques involve dynamically controlling the switching states of power switches in both legs simultaneously in order to maintain a consistent equivalent phase shift angle between those legs at the given operating point while enabling each leg to dynamically alternate between leading and lagging positions. The dynamic switching state transitions may be seamless, so as not to introduce any transients into the rest of the circuit. By implementing this approach, the techniques achieve a balanced loss distribution between the two legs, thereby facilitating higher power density operation.

### FIELD OF THE DISCLOSURE

This document pertains generally, but not by way of limitation, to isolated DC-DC converters.

### BACKGROUND

Phase-Shifted Full Bridges (PSFB) and Dual Active Bridges (DAB) are types of DC-DC converters used in high-efficiency power conversion applications. Both PSFB and DAB converters are suitable for a wide range of applications that require efficient power conversion. These converters utilize phase-shifting techniques to achieve zero-voltage switching (ZVS) and/or zero-current switching (ZCS), which reduces switching losses and improves overall efficiency. Their ability to handle power flow makes them ideal for applications such as renewable energy systems, energy storage systems, and electric vehicle (EV) charging infrastructure.

The PSFB converter operates with a phase-shift control technique that involves shifting the phase of the gate signals to achieve zero-voltage state. It typically uses a single full bridge on the primary side and a rectifier bridge on the secondary side. The control of a PSFB converter involves managing the phase shift between the primary bridge switches to achieve zero-volt seconds across one fundamental switching cycle. This requires precise timing and control, often handled by digital controllers. The control strategy is typically simpler compared to DAB.

The DAB converter includes two active bridges, one on the primary side and one on the secondary side, allowing for efficient bidirectional power transfer. The phase shift between the switches residing on the two bridges (primary and secondary bridge) controls the power flow and could achieve soft switching (ZVS and/or ZCS) in both directions. The control of a DAB converter involves managing the phase shift between two active bridges to regulate power flow in both directions. This requires more complex control algorithms to ensure efficient and stable operation, especially during transitions between charging and discharging modes.

U.S. Pat. No. 7,652,899 describes a switching sequence of a phase-shifted zero-voltage-transition (PS-ZVT) full bridge converter circuit that is alternated between two modes by periodically reversing the switching sequence for diagonally opposed switching devices of the bridge. Over a period of operation, each of the switching devices periodically conducts the entire free-wheeling current that occurs during load current reversal transitions so as to balance their average power dissipation and reduce the overall power dissipation of the converter circuit.

### SUMMARY OF THE DISCLOSURE

This disclosure describes techniques that address the unequal loss distribution between switches in two H bridge legs of two-level PSFB and DAB converters, where one leg reaches its temperature limit sooner than the other leg due to imbalanced losses. The techniques involve dynamically controlling the switching states of power switches in both legs simultaneously in order to maintain a consistent equivalent phase shift angle between those legs at the given operating point while enabling each leg to dynamically alternate between leading and lagging positions. The dynamic switching state transitions may be seamless, so as not to introduce any transients into the rest of the circuit. By implementing this approach, the techniques achieve a balanced loss distribution between the two legs, thereby facilitating higher power density operation.

In some aspects, this disclosure is directed to a two-level DC-DC converter comprising: a primary side full bridge circuit including: a first leg having a first electronic switch and a second electronic switch; and a second leg having a third electronic switch and a fourth electronic switch, wherein the primary side full bridge circuit is configured to generate a first voltage, and wherein configurations of the first electronic switch, the second electronic switch, the third electronic switch, and the fourth electronic switch define an operating cycle pattern for the primary side full bridge circuit; a secondary side power stage circuit including a second plurality of electronic components, the secondary side power stage circuit configured to generate a second voltage; a transformer coupled between the primary side full bridge circuit and the secondary side power stage circuit; and a control circuit configured for: controlling an operation of the first electronic switch, the second electronic switch, the third electronic switch, and the fourth electronic switch to use a first zero state, a second zero state, a third zero state, and a fourth zero state within the operating cycle pattern so as to balance a number of times the first electronic switch, the second electronic switch, the third electronic switch, and the fourth electronic switch are used.

In some aspects, this disclosure is directed to a method of operating a two-level DC-DC converter having a primary side full bridge circuit and a secondary side power stage circuit, the primary side full bridge circuit including a first leg having a first electronic switch and a second electronic switch and a second leg having a third electronic switch and a fourth electronic switch, the method comprising: controlling the first electronic switch, the second electronic switch, the third electronic switch, and the fourth electronic switch to define an operating cycle pattern having an active positive state, an active negative state, a first zero state, a second zero state, a third zero state, and a fourth zero state over one operating cycle for the primary side full bridge circuit; and using the first zero state, the second zero state, the third zero state, and the fourth zero state within the operating cycle pattern so as to balance a number of times the first electronic switch, the second electronic switch, the third electronic switch, and the fourth electronic switch are used.

In some aspects, this disclosure is directed to a control circuit for a two-level DC-DC converter, the two-level DC-DC converter including a primary side full bridge circuit having a first leg having a first electronic switch and a second electronic switch, and a second leg having a third electronic switch and a fourth electronic switch, wherein the primary side full bridge circuit is configured to generate a first voltage, and wherein configurations of the first electronic switch, the second electronic switch, the third electronic switch, and the fourth electronic switch define an operating cycle pattern having an active positive state, an active negative state, a first zero state, a second zero state, a third zero state, and a fourth zero state over one operating cycle for the primary side full bridge circuit, the two-level DC-DC converter further including a secondary side power stage circuit including a second plurality of electronic components, the secondary side power stage circuit configured to generate a second voltage, a transformer coupled between the primary side full bridge circuit and the secondary side power stage circuit, the control circuit comprising: a PI controller and a phase shift angle circuit configured for: controlling an operation of the first electronic switch, the second electronic switch, the third electronic switch, and the fourth electronic switch to use a first zero state, a second zero state, a third zero state, and a fourth zero state within the operating cycle pattern so as to balance a number of times the first electronic switch, the second electronic switch, the third electronic switch, and the fourth electronic switch are used.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a perspective view of an example of an electric machine that may implement various DC converter techniques of this disclosure.

FIG. 2 is a diagrammatic view of an example of an electric powertrain using the DC/DC converters of this disclosure.

FIG. 3 is a schematic illustration of an example of a two-level DC-DC converter that may implement various techniques of this disclosure.

FIG. 4 is a table depicting an example of an operating cycle pattern over multiple operating cycles that may be used to control the switches in a primary side full bridge circuit of a two-level DC-DC converter, in accordance with this disclosure.

FIG. 5 is a schematic illustration of another example of a two-level DC-DC converter that may implement various techniques of this disclosure.

FIG. 6 is a table depicting an example of an operating cycle pattern over multiple operating cycles that may be used to control the switches in a primary side full bridge circuit of a two-level DC-DC converter, in accordance with this disclosure.

FIG. 7 is a block diagram of an example of a control circuit that may implement various techniques of this disclosure.

FIG. 8 is a flow diagram of an example of a method of operating a two-level DC-DC converter using various techniques of this disclosure.

### DETAILED DESCRIPTION

The present inventors have recognized that two-level phase-shifted full bridge (PSFB) and dual active bridge (DAB) converters, operated in phase-shifted control mode, have inherent unequal loss distribution between switches in the two legs of the H bridge. This imbalance in losses between the two legs, which may be referred to as leading and lagging legs, results in the switches of the lagging/leading leg reaching their rated temperature limit sooner than the switches of the leading/lagging leg. Given that power semiconductor switches are the major components in PSFB and DAB converter topologies, the thermal limitations caused by the imbalances in the two legs may lead to lower a power density of the overall converter.

This disclosure describes techniques that address the unequal loss distribution between switches in two H bridge legs of two-level PSFB and DAB converters, where one leg reaches its temperature limit sooner than the other leg due to imbalanced losses. The techniques involve dynamically controlling the switching states of power switches in both legs simultaneously in order to maintain a consistent equivalent phase shift angle between those legs at the given operating point while enabling each leg to dynamically alternate between leading and lagging positions. The dynamic switching state transitions may be seamless, so as not to introduce any transients into the rest of the circuit. By implementing this approach, the techniques achieve a balanced loss distribution between the two legs, thereby facilitating higher power density operation.

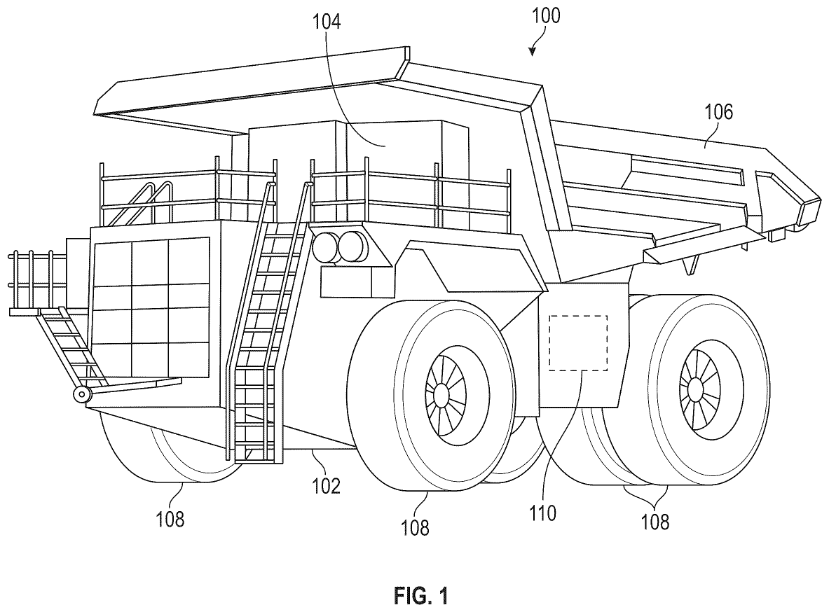

FIG. 1 is a perspective view of an example of an electric machine that may implement various DC converter techniques of this disclosure. A non-limiting example of machine 100 is shown in FIG. 1. The machine 100 may be any stationary or mobile machine powered, at least partially, by batteries. The machine 100 may be a mining truck, as depicted, or may alternatively embody an on-highway or off-highway machine or any other vehicle that is configured to be propelled.

In some examples, the machine 100 includes a frame 102 supporting at least an operator control station 104 and a dump body 106. Traction components 108 may form part of a wheel-drive system, a track-drive system, or any other type of drive system configured to propel the machine 100. Examples of traction components include wheels, track(s), or a combination of wheels and one or more tracks. The traction components 108 may be powered by a drive system, discussed below, supported by the frame 102.

The machine 100 also includes an electrical architecture 110. The electrical architecture 110 may include a DC power source, including but not limited to a battery module, that may supply power to, among other things, an electric motor. The electric motor may supply rotational power to one or more systems, such as a system configured to operate various hydraulics of the dump body 106. The techniques of this disclosure are applicable generally to industrial vehicles including, but not limited to, continuous miners, feeder breakers, roof bolters, utility vehicles for mining, underground mining loaders, underground articulated trucks, or any other vehicle used for industrial purposes, such as hauling, excavating, drilling, loading, dumping, compacting, etc. Further, the techniques of this disclosure, while especially suited to use in battery-powered vehicles, also could be used in hybrid-powered vehicles, and internal-combustion-powered vehicles.

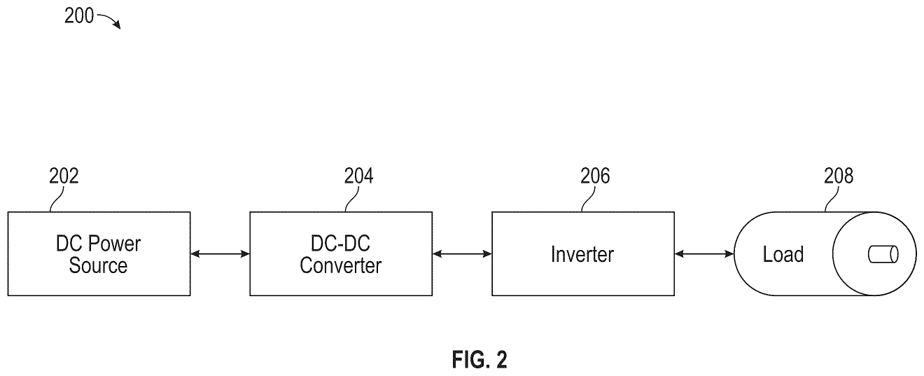

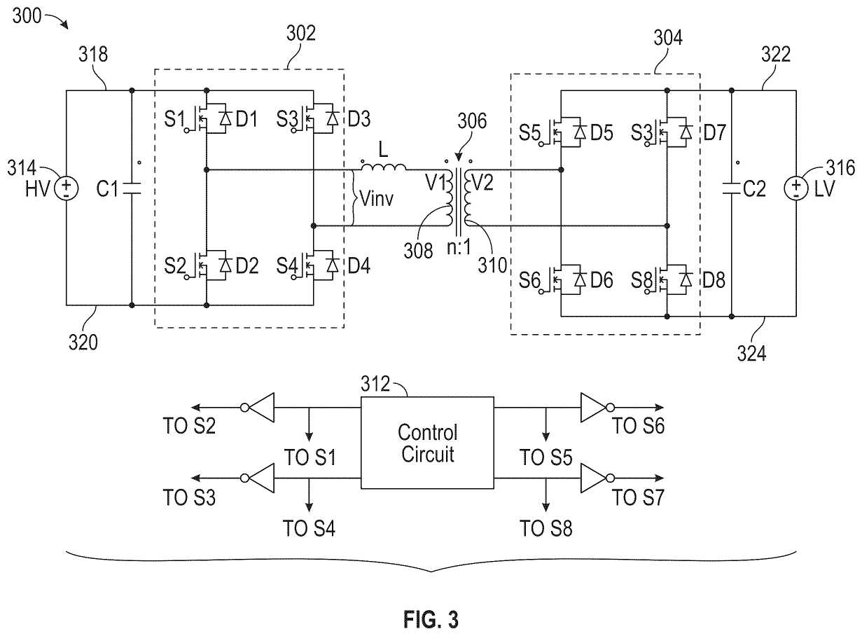

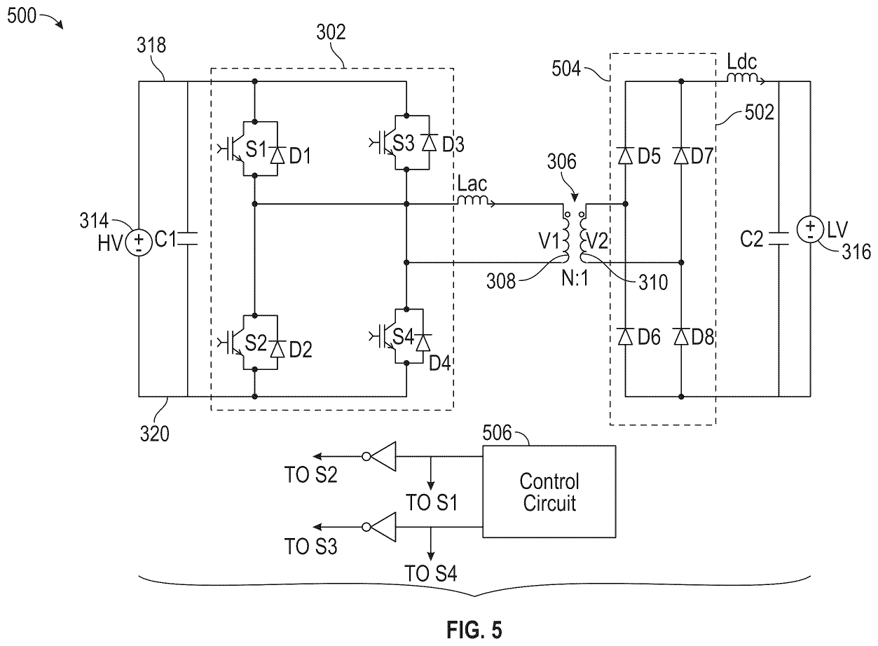

FIG. 2 is a diagrammatic view of an example of an electric powertrain using the DC/DC converter of this disclosure. The powertrain 200 may be used in combination with an electric machine, such as the machine 100 of FIG. 1. In the examples shown, the powertrain 200 includes a DC power source 202, such as one or more battery modules that each include one or more battery cells. The DC power source 202 is coupled to a two-level DC-DC converter 204 configured to implement various techniques of this disclosure, such as the DAB converter 300 of FIG. 3 and/or the two-level phase-shifted full bridge (PSFB) 500 of FIG. 5.

The DC-DC converter 204 is coupled to an inverter 206, which generates an AC voltage from the output of the DC-DC converter 204. An electrically drivable load 208, such as a motor of an electric machine is coupled to the inverter 206.

FIG. 3 is a schematic illustration of an example of a two-level DC-DC converter 300 that may implement various techniques of this disclosure. The two-level DC-DC converter 300 may be used with the machine of FIG. 1.

The two-level DC-DC converter 300 includes a two-level primary side full bridge circuit 302 and a secondary side power stage circuit 304. In particular, the secondary side power stage circuit 304 includes a secondary side full bridge circuit and, as such, the two-level DC-DC converter 300 is a dual-active bridge circuit. In the example shown, the secondary side power stage circuit 304 is a two-level circuit.

The primary side full bridge circuit 302 includes a plurality of electronic components, including a plurality of electronic switches S1-S4 paired with corresponding freewheeling diodes D1-D4. The switches S1 and S3 are coupled with a positive voltage rail 318 and the switches S2 and S4 are coupled with a negative voltage rail 320.

The secondary side power stage circuit 304 includes a plurality of electronic components, including a plurality of electronic switches S5-S8 paired with corresponding freewheeling diodes D5-D8. The switches S5 and S7 are coupled with a positive voltage rail 322 and the switches S6 and S8 are coupled with a negative voltage rail 324.

The two-level DC-DC converter 300 includes a transformer 306 coupled between the primary side full bridge circuit 302 and the secondary side power stage circuit 304. The transformer 306 includes a turns ratio of n:1. The two-level DC-DC converter 300 includes an inductor L coupled between the primary side full bridge circuit 302 and a primary winding 308 of the transformer 306.

The primary side full bridge circuit 302 is configured to generate a voltage V1 at the primary winding 308 of the transformer 306 and the secondary side power stage circuit 304 is configured to generate a voltage V2 at a secondary winding 310 of the transformer 306. A control circuit 312 is configured to, among other things, generate control signals to control operation of the switches S1-S8 so that the primary side full bridge circuit 302 and the secondary side power stage circuit 304 may generate the voltages V1, V2, respectively.

The primary side full bridge circuit 302 is coupled to a first voltage source 314 HV and a capacitor C1. In some examples, the first voltage source 314 is an external power source, such as a trolley system that provides power to electrical architecture via overhead lines or other infrastructure. The first voltage source 314 may provide a voltage greater than 2500V, such as 2700V-2800V. The secondary side power stage circuit 304 is coupled to a second voltage source 316 LV and a capacitor C2. In some examples, the second voltage source 316 is a battery.

The sets of electronic switches (S1, S2), (S4, S3), (S5, S6), and (S7, S8) are complementary pairs, such as with each switch operating at 50% duty cycle, respectively.

Thus, if S1 is ON then S2 will be OFF and if S1 is OFF then S2 will be ON, for example. Each set of electronic switches is referred to as a leg, with the switches S1 and S2 forming a first leg and the switches S3 and S4 forming a second leg.

The control circuit 312 is configured for controlling the operation of the electronic switches S1-S4 of the primary side full bridge circuit 302 so as to define an operating cycle pattern of active state, zero state, active state, zero state, and so forth. When the switches are in an active state, they are being actively controlled to conduct and allow current to flow through the circuit. In some examples, the control circuit 312 achieves this through pulse-width modulation (PWM) techniques. The active state includes both an active positive state and an active negative state. In the active positive state, the control circuit 312 turns ON both the switch S1 and the switch S4 so as to couple the primary winding 308 of the transformer 306, via the inductor L, to the positive rail. In the active negative state, the control circuit 312 turns ON the switch S2 and the switch S3 so as to couple the primary winding 308, via the inductor L, to the negative rail.

In the active positive state, the switches on the primary side are configured in such a way that energy is transferred from the primary side (input side) to the secondary side (output side) with a positive power flow direction. In the active negative state, the switches are configured to allow energy transfer in the opposite direction, which means power is flowing from the secondary side back to the primary side, or the phase shift is such that the power flow direction is reversed.

Between the active positive state and the active negative state, the operating cycle pattern includes a zero state, or zero voltage state. In the zero state, the control circuit 312 turns ON one of the switches (with the other switches in the primary side full bridge circuit 302 turned OFF) and current freewheels through a diode. For example, the control circuit 312 turns ON the switch S3, turns OFF the switches S1, S2, and S4, and current freewheels through the diode D1. There is no net power transfer between the primary and secondary sides during a zero state.

The present inventors have recognized that two-level DC-DC converters, such as phase-shifted full bridge circuits (PSFB) and dual active bridge (DAB) circuits, that are operated in phase-shifted control mode, have inherent unequal loss distribution between switches in the two legs of primary side full bridge circuit, e.g., the H bridge. This imbalance in losses between the two legs, such as a first leg including the switches S1 and S2 and a second leg including the switches S3 and S4 (which can be referred to as leading and lagging legs), results in switches of the lagging/leading leg reaching their rated temperature limit sooner than the switches of the leading/lagging leg. Because power semiconductor switches are major components in PSFB and DAB converter topologies, the thermal limitations lead to lower power density of the converter. The present inventors have recognized a need to address the unequal loss distribution between switches in the two legs of two-level PSFB and DAB converters.

This disclosure describes techniques for dynamically controlling the switching states of the switches in both legs of a primary side full bridge circuit of a two-level DC-DC converter simultaneously in order to maintain a consistent equivalent phase shift angle between those legs at the given operating point while enabling each leg to dynamically alternate between leading and lagging positions. It is desirable for these dynamic switching state transitions to be seamless, so as not to introduce any transients into the rest of the circuit. By implementing this approach, these techniques achieve a balanced loss distribution between the two legs, thereby facilitating higher power density operation.

Existing approaches to implementing zero states of the operating cycle pattern control one of the switches in the top half of the primary side full bridge circuit 302 to turn ON, e.g., the switch S3 while the diode D1 freewheels. Then, in the next zero state, the control circuit 312 controls one of the switches in the bottom half of the primary side full bridge circuit 302 to turn ON, e.g., the switch S4 while the diode D2 freewheels. This pattern continues and results in the overuse of the switches S3 and S4 because the switches S1 and S2 are not used in the zero states.

The present inventors have recognized the desirability of balancing the use of the switches S1-S4 of the primary side full bridge circuit 302 during the zero states. Balancing the use of the switches S1-S4 during the zero states assists in balancing the loss distribution between the two legs of the primary side full bridge circuit 302.

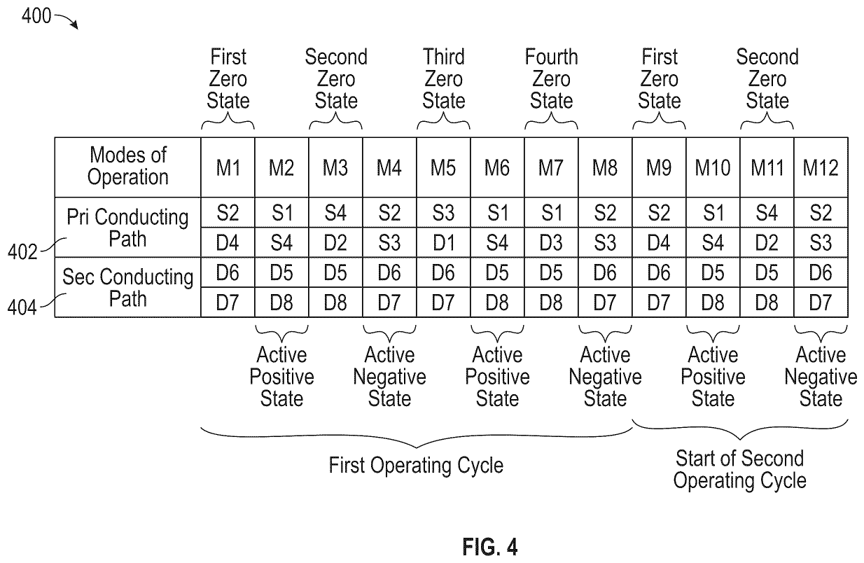

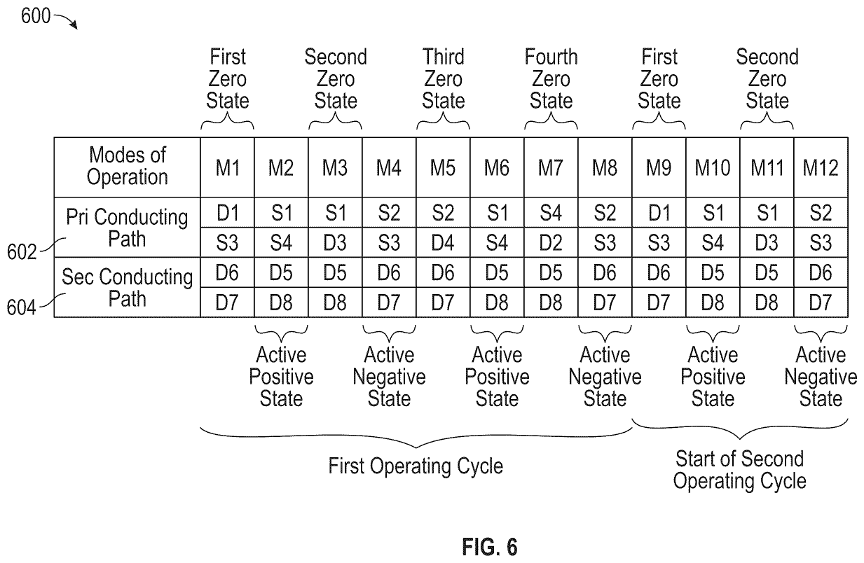

Using the techniques of this disclosure, the ON/OFF configurations of the switches S1-S4 define an operating cycle pattern that includes an active positive state, an active negative state, a first zero state, a second zero state, a third zero state, and a fourth zero state over one operating cycle for the primary side full bridge circuit 302, such as shown in FIGS. 4 and 6. A control circuit, such as the control circuit 312, controls the switches during the zero states over an operating cycle so as to balance a number of times the first electronic switch, the second electronic switch, the third electronic switch, and the fourth electronic switch are used during the zero states of the operating cycle, as described in more detail below.

FIG. 4 is a table depicting an example of an operating cycle pattern over multiple operating cycles that may be used to control the switches in a primary side full bridge circuit of a two-level DC-DC converter, in accordance with this disclosure. In particular, the table 400 depicts modes of operation M1-M12 that the control circuit 312 of FIG. 3 uses for controlling the operation of the switches S1-S8 of the two-level dual active bridge circuit of FIG. 3.

Each mode of operation includes switch configurations for the primary side conducting path 402 and the secondary side conducting path 404. The switches listed in each mode of operation in the table 400 are the switches that are ON in that mode, with all other switches OFF in that mode of operation. For example, in the primary side conducting path 402 in mode of operation M1, the switch S2 is in an ON state and diode D4 is conducting, and the switches S1, S3, and S4 of the primary side full bridge circuit 302 of FIG. 3 are in an OFF state.

Configurations of the switches S1-S4 of the primary side conducting path 402 define an operating cycle pattern that includes four zero states, an active positive state, and an active negative state. A cycle is complete when the four zero states, the active positive state, and the active negative state have been completed. For example, FIG. 4 depicts a first operating cycle that includes modes M1-M8. A second operating cycle begins at mode M9 but is not complete in FIG. 4.

Referring only to the primary side conducting path 402, the mode M1 is a first zero state, the mode M2 is an active positive state, the mode M3 is a second zero state, the mode M4 is an active negative state, the mode M5 is a third zero state, the mode M6 is an active positive state, the mode M7 is a fourth zero state, the mode M8 is an active negative state, the mode M9 is a first zero state, the mode M10 is an active positive state, the mode M11 is a second zero state, the mode M12 is an active negative state, and so forth. The secondary side conducting path 404 will not be discussed further and is only presented in the table 400 for completeness.

An active positive state is where both switches S1 and S4 are in an ON state and both switches S2 and S3 are in an OFF state. An active negative state is where both switches S2 and S3 are in an ON state and both switches S1 and S4 are in an OFF state.

In the zero states, one of the switches in either the top half or bottom half of the primary side full bridge circuit 302 is in an ON state while the remaining three switches of the primary side full bridge circuit 302 are in an OFF state. For example, as shown in FIG. 4, the first zero state in mode M1 depicts switch S2 in an ON state and switches S1, S3, and S4 in an OFF state. In the second zero state, switch S4 is in an ON state and the switches S1-S3 are in an OFF state. In the third zero state, switch S3 is in an ON state and the switches S1, S2, and S4 are in an OFF state. In the fourth zero state, switch S1 is in an ON state and the switches S2-S4 are in an OFF state.

Using the techniques of this disclosure, the operation of the switches used in the zero states is controlled so as to balance a number of times the first electronic switch, the second electronic switch, the third electronic switch, and the fourth electronic switch are used during the zero states of an operating cycle. For example, mode M1 (first zero state) uses the switch S2, mode M3 (second zero state) uses the switch S4, mode M5 (third zero state) uses the switch S3, and mode M7 (fourth zero state) uses the switch S1. In this manner, over an operating cycle, each of the switches S1-S4 is used only once during a corresponding zero state mode.

By controlling the operation of the switches S1-S4 of the primary side full bridge circuit 302, no one switch is overused. The control circuit controls the operation of the electronic switches over the course of the operating cycles so as to balance the use of the switches S1-S4, which reduces the loss distribution between the two legs of the primary side full bridge circuit 302 of FIG. 3.

It should be noted that the switching pattern shown in FIG. 4 is an example of a switching pattern. In the first zero state and the second zero state, one of the second electronic switch S2 and the fourth electronic switch S4 is in an ON state and the other of the second electronic switch S2 and the fourth electronic switch S4 in an OFF state, and both the first electronic switch S1 and the third electronic switch S3 are in the OFF state. In the third zero state and the fourth zero state, one of the first electronic switch S1 and the third electronic switch S3 is in an ON state and the other of the first electronic switch S1 and the third electronic switch S3 is in an OFF state, and both the second electronic switch S2 and the fourth electronic switch S4 are in the OFF state. In an equivalent switching pattern, the first zero state and the second zero state may be interchanged. In another equivalent switching pattern, the third zero state and the fourth zero state may be interchanged. As mentioned above, the techniques of this disclosure are directed to controlling the operation of the switches such that over an operating cycle, each of the switches S1-S4 is used only once during a corresponding zero state mode.

FIG. 5 is a schematic illustration of a two-level DC-DC converter 500 that may implement various techniques of this disclosure. The two-level DC-DC converter 500 may be used with the machine of FIG. 1.

The two-level DC-DC converter 500 includes a two-level primary side full bridge circuit 302 and a secondary side power stage circuit 504, each having a plurality of electronic components. The primary side full bridge circuit 302 is similar to the primary side full bridge circuit 302 of FIG. 3 and, for conciseness, will not be described in detail again. The secondary side power stage circuit 504 includes a plurality of diodes D5-D8 arranged as a rectifier circuit. The two-level DC-DC converter 500 is an example of a phase-shifted full bridge circuit.

The primary side full bridge circuit 302 includes a plurality of electronic components, including a plurality of electronic switches S1-S4 paired with corresponding freewheeling diodes D1-D4. The switches S1 and S3 are coupled with a positive voltage rail 318 and the switches S2 and S4 are coupled with a negative voltage rail 320.

The two-level DC-DC converter 500 includes a transformer 306 coupled between the primary side full bridge circuit 302 and the secondary side power stage circuit 504. The transformer 306 includes a turns ratio of n:1. The two-level DC-DC converter 500 includes an inductor Lac coupled between the primary side full bridge circuit 302 and a primary winding 308 of the transformer 306.

The primary side full bridge circuit 302 is configured to generate a voltage V1 at the primary winding 308 of the transformer 306 and the secondary side power stage circuit 504 is configured to generate a voltage V2 at a secondary winding 310 of the transformer 306. A control circuit 506 is configured to, among other things, generate control signals to control operation of the switches S1-S4 so that the primary side full bridge circuit 302 and the secondary side power stage circuit 504 may generate the voltages V1, V2, respectively.

The primary side full bridge circuit 302 is coupled to a first voltage source 314 HV and a capacitor C1. In some examples, the first voltage source 314 is an external power source, such as a trolley system that provides power to electrical architecture via overhead lines or other infrastructure. The first voltage source 314 may provide a voltage greater than 2500V, such as 2700V-2800V. The secondary side power stage circuit 304 is coupled to a second voltage source 316 LV and a capacitor C2. In some examples, the second voltage source 316 is a battery.

The sets of electronic switches (S1, S2) and (S4, S3) are complementary pairs, such as with each switch operating at 50% duty cycle, respectively. Thus, if S1 is ON then S2 will be OFF and if S1 is OFF then S2 will be ON, for example. Each set of electronic switches is referred to as a leg, with the switches S1 and S2 forming a first leg and the switches S3 and S4 forming a second leg.

The control circuit 506 is configured for controlling the operation of the electronic switches S1-S4 of the primary side full bridge circuit 302 so as to define an operating cycle pattern of active state, zero state, active state, zero state, and so forth. These states were described in detail above with respect to FIG. 3 and FIG. 4 and, for conciseness, will not be described in detail again.

Using the techniques of this disclosure, the ON/OFF configurations of the switches S1-S4 define an operating cycle pattern of an active positive state, a first zero state, an active negative state, and a second zero state over one operating cycle for the primary side full bridge circuit 302. A control circuit, such as the control circuit 506, controls the switches so as to balance a number of times the first electronic switch, the second electronic switch, the third electronic switch, and the fourth electronic switch are used during the zero states of an operating cycle, as described in more detail below.

FIG. 6 is a table depicting another example of an operating cycle pattern over multiple operating cycles that may be used to control the switches in a primary side full bridge circuit of a two-level DC-DC converter, in accordance with this disclosure. The table 600 depicts modes of operation M1-M12.

Each mode of operation includes switch configurations for the primary side conducting path 602 and the secondary side conducting path 604. The switches listed in each mode of operation in the table 600 are the switches that are ON in that mode, with all other switches OFF in that mode of operation. For example, in the primary side conducting path 602 in mode M1, the switch S3 is in an ON state and diode D1 is conducting, with the switches S1, S2, and S4 of the primary side full bridge circuit 302 of FIG. 5 are in OFF state.

Configurations of the switches S1-S4 of the primary side conducting path 402 define an operating cycle pattern that includes four zero states, an active positive state, and an active negative state. A cycle is complete when the four zero states, the active positive state, and the active negative state have been completed. For example, FIG. 6 depicts a first operating cycle that includes modes M1-M8. A second operating cycle begins at mode M9 but is not complete in FIG. 6.

Referring only to the primary side conducting path 602, the mode M1 is a first zero state, the mode M2 is an active positive state, the mode M3 is a second zero state, the mode M4 is an active negative state, the mode M5 is a third zero state, the mode M6 is an active positive state, the mode M7 is a fourth zero state, the mode M8 is an active negative state, the mode M9 is a first zero state, the mode M10 is an active positive state, the mode M11 is a second zero state, the mode M12 is an active negative state, and so forth. The secondary side conducting path 604 will not be discussed further and is only presented in the table 600 for completeness.

An active positive state is where both switches S1 and S4 are in an ON state and both switches S2 and S3 are in an OFF state. An active negative state is where both switches S2 and S3 are in an ON state and both switches S1 and S4 are in an OFF state.

In the zero states, one of the switches in either the top half or bottom half of the primary side full bridge circuit 302 of FIG. 5 is in an ON state while the remaining three switches of the primary side full bridge circuit 302 are in an OFF state. For example, as shown in FIG. 6, the first zero state in mode M1 depicts switch S3 in an ON state and switches S1, S2, and S4 in an OFF state. In the second zero state, switch S1 is in an ON state and the switches S2-S4 are in an OFF state. In the third zero state, switch S2 is in an ON state and the switches S1, S3, and S4 are in an OFF state. In the fourth zero state, switch S4 is in an ON state and the switches S1-S3 are in an OFF state.

By using the techniques of this disclosure, the control circuit 506 of FIG. 5 controls the operation of the switches used in the zero states so as to balance a number of times the first electronic switch, the second electronic switch, the third electronic switch, and the fourth electronic switch are used during the zero states of an operating cycle. For example, mode M1 (first zero state) uses the switch S3, mode M3 (second zero state) uses the switch S1, mode M5 (third zero state) uses the switch S2, and mode M7 (fourth zero state) uses the switch S4. In this manner, over an operating cycle, each of the switches S1-S4 is used only once during a corresponding zero state mode. By controlling the operation of the switches S1-S4 of the primary side full bridge circuit 302 of FIG. 5, no one switch is overused. The control circuit controls the operation of the electronic switches over the course of the operating cycles so as to balance the use of the switches S1-S4 over an operating cycle, which reduces the loss distribution between the two legs of the primary side full bridge circuit 302 of FIG. 5.

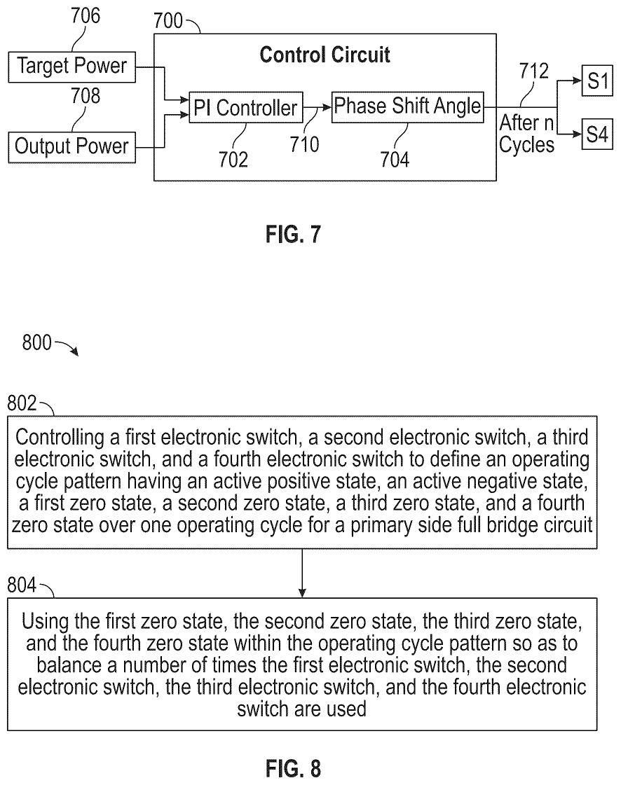

FIG. 7 is a block diagram of an example of a control circuit 700 that may implement various techniques of this disclosure. The control circuit 700 is an example of the control circuit 312 of FIG. 3 and the control circuit 506 of FIG. 5.

In the example shown, the control circuit 700 includes a Proportional Integral (PI) controller, namely PI controller 702, coupled with a phase shift angle circuit 704. The target power 706 and the output power 708 are input signals to the PI controller 702. The PI controller 702 determined an error by subtracting the output power 708 from the target power 706. The PI controller 702 then adjusts its output based on this error using proportional and integral terms, generating a control signal 710 that is applied to the phase shift angle circuit 704 and used to adjust the phase shift angle.

The phase shift angle circuit 704 receives the control signal 710 from the PI controller 702 and generates a signal 712 representing a phase shift angle, which determines the timing relationship between the leading and lagging legs of the primary side full bridge circuit 302 of the two-level DC-DC converter. The phase shift angle is used to generate gate signals to control the switches in the two-level DC-DC converter, such as the switches S1 and S4 as shown.

As described above, the switches S1-S4 of the primary side full bridge circuit 302 are controlled in such a way that there are active states and zero states. The active states refer to the periods when power is actively transferred between the primary and secondary sides of the converter, while the zero states refer to the periods when no power is being transferred. The leading leg and lagging leg terminology refer to the two sets of switches on the primary and secondary sides of the converter, respectively. The control circuit 700 adjusts the phase shift between the leading and lagging legs to regulate the power transfer.

Using the techniques of this disclosure, the control circuit 700 dynamically controls the switching such that the phase shift angle between the leading leg and lagging leg remains unchanged but each leg dynamically alternates between a leading and a lagging position. The dynamic switching state transitions (shifts) are seamless such that no transients are imposed on the circuit.

Transition (shift) may occur at any point in time, but produces transient voltages on the output that result in transient currents as well, which is a potential problem for many reasons including transformer saturation, increased device losses, and the like. Seamless transition is the implementation of phase shift during a first zero state or a second zero state that is free from DC voltages and/or any other type of unwanted transients of the output voltage of the primary side full bridge circuit. By using a seamless transition, the rest of the circuit, e.g., transformer and secondary bridge components, does not see the difference between the default and proposed dynamic shifting approach.

A phase shift occurs as the two-level DC-DC converter is leaving the zero state. That is, the control circuit 700 adjusts, during either the first zero state or second zero state, a phase angle between an electronic switch of the first leg and an electronic switch of the second leg.

For example, the control circuit 700 adjusts the phase angle between switch S1 and switch S4 during the first zero state (or the second zero state) and, after that, the two-level DC-DC converter enters an active positive state or an active negative state.

The phase shift angle is variable, depending on the desired voltage modulation, and may range from zero to 180 degrees. Toggling between switches S1 and S4 at the zero state is important for achieving seamless transition and balancing the loss distribution between the two legs of the primary side full bridge circuit and allows higher power density operation of the two-level DC-DC converter.

FIG. 8 is a flow diagram of an example of a method of operating a two-level DC-DC converter using various techniques of this disclosure.

At block 802, the method 800 includes controlling a first electronic switch, a second electronic switch, a third electronic switch, and a fourth electronic switch to define an operating cycle pattern having an active positive state, an active negative state, a first zero state, a second zero state, a third zero state, and a fourth zero state over one operating cycle for the primary side full bridge circuit. For example, the control circuit 312 of FIG. 3 or the control circuit 506 of FIG. 5 generates output signals to control the operation of switches S1-S4 to define an operating cycle pattern having an active positive state, an active negative state, a first zero state, a second zero state, a third zero state, and a fourth zero state over one operating cycle for the primary side full bridge circuit 302, such as shown in FIG. 4 and FIG. 6.

At block 804, the method 800 includes using the first zero state, the second zero state, the third zero state, and the fourth zero state within the operating cycle pattern so as to balance a number of times the first electronic switch, the second electronic switch, the third electronic switch, and the fourth electronic switch are used during the zero states of an operating cycle.

For example, as seen in FIG. 6, the control circuit 506 of FIG. 5 controls the operation of the switches during the first zero state, the second zero state, the third zero state, and the fourth zero state so that the use of the switches S1-S4 is balanced over an operating cycle. In the example shown in FIG. 6, the switches used in the zero states are, in order, S3, S1, S2, and S4. Over the operating cycle, the use of those switches balances. This is in contrast with existing approaches where one switch of the top half, e.g., switch S3, and one switch of the bottom half, e.g., switch S4, are used for each zero state, which may result in thermal issues with the overused switches.

In some examples, the method 800 further includes adjusting, during either the first zero state or second zero state, a phase angle between an electronic switch of the first leg and an electronic switch of the second leg. For example, the control circuit 506 adjusts a phase angle between switch S1 (first leg) and switch S4 (second leg) during the first zero state or the second zero state.

In some examples, the method 800 includes coupling the first electronic switch and the third electronic switch with a positive voltage rail, coupling the second electronic switch and the fourth electronic switch with a negative voltage rail, where the first zero state includes controlling: one of the second electronic switch and the fourth electronic switch to be in an ON state and the other of the second electronic switch and the fourth electronic switch to be in an OFF state, and both the first electronic switch and the third electronic switch to be in the OFF state, and where the second zero state includes controlling one of the first electronic switch and the third electronic switch to be in an ON state and the other of the first electronic switch and the third electronic switch to be in an OFF state, and both the second electronic switch and the fourth electronic switch to be in the OFF state.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples. ” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more. ” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein. ” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A two-level DC-DC converter comprising:
a primary side full bridge circuit including:
a first leg having a first electronic switch and a second electronic switch; and
a second leg having a third electronic switch and a fourth electronic switch,
wherein the primary side full bridge circuit is configured to generate a first voltage, and
wherein configurations of the first electronic switch, the second electronic switch, the third electronic switch, and the fourth electronic switch define an operating cycle pattern for the primary side full bridge circuit;
a secondary side power stage circuit including a second plurality of electronic components, the secondary side power stage circuit configured to generate a second voltage;
a transformer coupled between the primary side full bridge circuit and the secondary side power stage circuit; and
a control circuit configured for:
controlling an operation of the first electronic switch, the second electronic switch, the third electronic switch, and the fourth electronic switch to use a first zero state, a second zero state, a third zero state, and a fourth zero state within the operating cycle pattern so as to balance a number of times the first electronic switch, the second electronic switch, the third electronic switch, and the fourth electronic switch are used.

2. The two-level DC-DC converter of claim 1, wherein the secondary side power stage circuit includes a secondary side full bridge circuit, and wherein the two-level DC-DC converter is a dual-active bridge circuit.

3. The two-level DC-DC converter of claim 2, wherein the secondary side full bridge circuit is a two-level circuit.

4. The two-level DC-DC converter of claim 1, wherein the secondary side power stage circuit includes a rectifier circuit, and wherein the two-level DC-DC converter is a phase-shifted full bridge circuit.

5. The two-level DC-DC converter of claim 1, wherein the control circuit configured for controlling the operation of the first electronic switch, the second electronic switch, the third electronic switch, and the fourth electronic switch to use a first zero state, a second zero state, a third zero state, and a fourth zero state within the operating cycle pattern so as to balance the number of times the first electronic switch, the second electronic switch, the third electronic switch, and the fourth electronic switch are used is configured for:
controlling the operation of the first electronic switch, the second electronic switch, the third electronic switch, and the fourth electronic switch to generate the operating cycle pattern of:
the first zero state, the active positive state, the second zero state, the active negative state, the third zero state, the active positive state, the fourth zero state, and the active negative state.

6. The two-level DC-DC converter of claim 1, wherein the first electronic switch and the third electronic switch are coupled with a positive voltage rail, wherein the second electronic switch and the fourth electronic switch are coupled with a negative voltage rail,
wherein the first zero state includes:
one of the second electronic switch and the fourth electronic switch in an ON state and the other of the second electronic switch and the fourth electronic switch in an OFF state, and
both the first electronic switch and the third electronic switch in the OFF state, and
wherein the second zero state includes:
one of the first electronic switch and the third electronic switch in an ON state and the other of the first electronic switch and the third electronic switch in an OFF state, and
both the second electronic switch and the fourth electronic switch in the OFF state.

7. The two-level DC-DC converter of claim 1, wherein the control circuit is configured for:
adjusting, during either the first zero state or second zero state, a phase angle between an electronic switch of the first leg and an electronic switch of the second leg.

8. A method of operating a two-level DC-DC converter having a primary side full bridge circuit and a secondary side power stage circuit, the primary side full bridge circuit including a first leg having a first electronic switch and a second electronic switch and a second leg having a third electronic switch and a fourth electronic switch, the method comprising:
controlling the first electronic switch, the second electronic switch, the third electronic switch, and the fourth electronic switch to define an operating cycle pattern having an active positive state, an active negative state, a first zero state, a second zero state, a third zero state, and a fourth zero state over one operating cycle for the primary side full bridge circuit; and
using the first zero state, the second zero state, the third zero state, and the fourth zero state within the operating cycle pattern so as to balance a number of times the first electronic switch, the second electronic switch, the third electronic switch, and the fourth electronic switch are used.

9. The method of claim 8, wherein using the first zero state, the second zero state, the third zero state, and the fourth zero state within the operating cycle pattern so as to balance a number of times the first electronic switch, the second electronic switch, the third electronic switch, and the fourth electronic switch are used includes:
generating the operating cycle pattern of:
the first zero state, the active positive state, the second zero state, the active negative state, the third zero state, the active positive state, the fourth zero state, and the active negative state.

10. The method of claim 9, comprising:
coupling the first electronic switch and the third electronic switch with a positive voltage rail;
coupling the second electronic switch and the fourth electronic switch with a negative voltage rail;
wherein the first zero state includes controlling:
one of the second electronic switch and the fourth electronic switch to be in an ON state and the other of the second electronic switch and the fourth electronic switch to be in an OFF state, and
both the first electronic switch and the third electronic switch to be in the OFF state, and
wherein the second zero state includes controlling:
one of the first electronic switch and the third electronic switch to be in an ON state and the other of the first electronic switch and the third electronic switch to be in an OFF state, and
both the second electronic switch and the fourth electronic switch to be in the OFF state.

11. The method of claim 8, comprising:
adjusting, during either the first zero state or second zero state, a phase angle between an electronic switch of the first leg and an electronic switch of the second leg.

12. The method of claim 8, wherein the secondary side power stage circuit includes a secondary side full bridge circuit, and wherein the two-level DC-DC converter is a dual-active bridge circuit.

13. The method of claim 12, wherein the secondary side full bridge circuit is a two-level circuit.

14. The method of claim 8, wherein the secondary side power stage circuit includes a rectifier circuit, and wherein the two-level DC-DC converter is a phase-shifted full bridge circuit.

15. A control circuit for a two-level DC-DC converter, the two-level DC-DC converter including a primary side full bridge circuit having a first leg having a first electronic switch and a second electronic switch, and a second leg having a third electronic switch and a fourth electronic switch, wherein the primary side full bridge circuit is configured to generate a first voltage, and wherein configurations of the first electronic switch, the second electronic switch, the third electronic switch, and the fourth electronic switch define an operating cycle pattern having an active positive state, an active negative state, a first zero state, a second zero state, a third zero state, and a fourth zero state over one operating cycle for the primary side full bridge circuit, the two-level DC-DC converter further including a secondary side power stage circuit including a second plurality of electronic components, the secondary side power stage circuit configured to generate a second voltage, a transformer coupled between the primary side full bridge circuit and the secondary side power stage circuit, the control circuit comprising:
a PI controller and a phase shift angle circuit configured for:
controlling an operation of the first electronic switch, the second electronic switch, the third electronic switch, and the fourth electronic switch to use a first zero state, a second zero state, a third zero state, and a fourth zero state within the operating cycle pattern so as to balance a number of times the first electronic switch, the second electronic switch, the third electronic switch, and the fourth electronic switch are used.

16. The control circuit of claim 15, wherein the PI controller and the phase shift angle circuit are configured for:
controlling the operation of the first electronic switch, the second electronic switch, the third electronic switch, and the fourth electronic switch to generate the operating cycle pattern of:
the first zero state, the active positive state, the second zero state, the active negative state, the third zero state, the active positive state, the fourth zero state, and the active negative state.

17. The control circuit of claim 15, wherein the PI controller and the phase shift angle circuit are configured for:
adjusting, during either the first zero state or second zero state, a phase angle between an electronic switch of the first leg and an electronic switch of the second leg.

18. The control circuit of claim 15, wherein the secondary side power stage circuit includes a secondary side full bridge circuit, and wherein the two-level DC-DC converter is a dual-active bridge circuit.

19. The control circuit of claim 18, wherein the secondary side full bridge circuit is a two-level circuit.

20. The control circuit of claim 15, wherein the secondary side power stage circuit includes a rectifier circuit, and wherein the two-level DC-DC converter is a phase-shifted full bridge circuit.
